(19) United States
(12) Patent Application Publication
(10) Pub. No.: US 2018/0025640 A1
(43) Pub. Date: Jan. 25, 2018

(54) Using Virtual Data To Test And Train Parking Space Detection Systems

(71) Applicant: Ford Global Technologies, LLC, Dearborn, MI (US)

(72) Inventors: Ashley Elizabeth Micks, Mountain View, CA (US); Jinesh J. Jain, Palo Alto, CA (US); Vidya Nariyambut Murali, Sunnyvale, CA (US); Harpreetsingh Banvait, Sunnyvale, CA (US); Sneha Kadetotad, Cupertino, CA (US); Peter Gyumyeong Joh, Bloomfield Hills, MI (US)

(21) Appl. No.: 15/214,269

(22) Filed: Jul. 19, 2016

(51) Int. Cl. G08G 1/14; G06N 99/00; G06F 17/50

(52) U.S. Cl. CPC G08G 1/14; G06F 17/5009; G06N 99/005

(57) ABSTRACT

The present invention extends to methods, systems, and computer program products for using virtual data to test and train parking space detection systems. Aspects of the invention integrate a virtual driving environment with sensor models (e.g., of a radar system) to provide virtual radar data in relatively large quantities in a relatively short amount of time. The sensor models perceive values for relevant parameters of a training data set. Relevant parameters can be randomized in the recorded data to ensure a diverse training data set with minimal bias. Since the driving environment is virtualized, the training data set can be generated alongside ground truth data. The ground truth data is used to annotate true locations, which are used to train a parking space classification algorithms to detect the free space boundaries.

### CROSS-REFERENCE TO RELATED APPLICATIONS

Not applicable.

### BACKGROUND

### 1. Field of the Invention

This invention relates generally to the field of parking space detection systems, and, more particularly, to using virtual data to test and train systems that detect available parking spaces.

### 2. Related Art

Parking can be a cumbersome process for a human driver. In the case of perpendicular parking or angle parking, it can be difficult to estimate when to turn in to a parking space, if there is going to be enough room on both sides of the vehicle, how to position the steering wheel such that the vehicle is equally spaced between the parking lines, and how far to pull into a parking space. In the case of parallel parking, it can be difficult to know if there is sufficient space to park a vehicle, when to start turning the steering wheel, and how far to pull into a space before correcting the steering wheel. These parking maneuvers can be further complicated in the presence of uneven terrain or in the presence of moving objects such as pedestrians, bicyclists, or other vehicles.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates using virtual data to test parking space detection.

FIG. 3 illustrates a flow chart of an example method for using virtual data to test parking space detection.

FIG. 4 illustrates an example computer architecture that facilitates using virtual data to train parking space detection.

FIG. 5 illustrates a flow chart of an example method for using virtual data to train parking space detection.

FIG. 6 illustrates an example parking environment.

### DETAILED DESCRIPTION

The present invention extends to methods, systems, and computer program products for using virtual data to test and train parking space detection systems.

Automated parking is one of the promising aspects of automated driving. Some vehicles already offer the ability to automatically execute a parallel parking maneuver. Solutions to automated parking are envisioned to be easily automated with high degrees of safety and repeatability. However, the success of these solutions depends highly on robustly estimating parking space geometry in essentially real time.

The radar, as a dynamic range sensor, works well to detect distances to obstacles from the perspective of a moving vehicle. However, these detections can be noisy. Various statistical regression-type techniques can be used to obtain a smooth, reliable estimate of the free space boundary. However, these techniques are difficult to scale and consistently repeat. Radar can suffer from multiple reflections in the presence of certain materials and objects, bringing uncertainty to the depth/space estimation. Another issue is that sufficient radar detections need to be acquired in order to determine the boundaries of a parking space. Acquiring sufficient radar detections has proven challenging to accomplish in a sufficiently short amount of time using existing techniques.

A deep learning approach can be used in boundary detection algorithms to achieve stable free parking space boundary estimation. The deep learning approach can operate in real time, requiring fewer data points and addressing the issues above. The boundary detection algorithms are trained and tested on large amounts of diverse data in order to produce a robust and unbiased neural network for this purpose. However, acquiring real world sensor data takes considerable time and resources. Acquiring real world sensor data can include driving around with sensors to collect data under various environmental conditions and physically setting up different parking scenarios manually. As such, the amount of time and effort required to produce a training dataset with minimal bias can be considerable if it consists entirely of real world data.

Aspects of the invention integrate a virtual driving environment with sensor models (e.g., of a radar system) to provide virtual radar data in relatively large quantities in a relatively short amount of time. Compared to real-world data, virtual data is cheaper in terms of time, money, and resources. Simulations can run faster than real time and can be run in parallel to go through a vast number of scenarios. Additionally, engineering requirements for setting up and running virtual scenarios are considerable reduced compared to setting up and running real-world scenarios manually.

The sensor models perceive values for relevant parameters of a training data set, such as, the positions and types of other vehicles in the parking environment, the types and materials of other surfaces in the area, the orientation of the vehicle relative to the parking spaces of interest, and the position of the virtual radar sensors relative to the other vehicles. Relevant parameters can be randomized in the recorded data to ensure a diverse training data set with minimal bias.

The training data set can be generated alongside ground truth data (i.e., actual values for relevant parameters). The ground truth data is known since the driving environment is virtualized. The ground truth data can be used to annotate the true locations of the free space boundaries relative to the virtual radar data. Annotated true locations can then be used for supervised learning, to train learning algorithms (e.g., neural networks) to detect the free space boundaries.

In one aspect, a virtual driving environment is created using three dimensional (“3D”) modeling and animation tools. For example, a 3D parking lot can be set up. A virtual vehicle can virtually drive through the virtual parking lot in a manner consistent with searching for parking place. The virtual vehicle is equipped with virtual radars (e.g., four corner radars) that record virtual radar data as the virtual vehicle virtually drives through the virtual parking lot. Essentially simultaneously, ground truth information about the boundaries of unoccupied park spaces is also recorded. Similar operations can be performed for additional parking lot layouts and arrangements of vehicles to obtain many hours (e.g., 20 or more hours) of driving data at nominal parking lot speeds.

Some of the virtual radar data along with corresponding ground truth data can be provided to a supervised learning process for a detection algorithm (e.g., a supervised learning algorithm, a neural network, etc.). Other annotated virtual radar data can be used to test the detection algorithm and quantify its performance after training. When a detection algorithm appears to be performing reasonably based on training with virtual data, the detection algorithm can also be tested on annotated real world data.

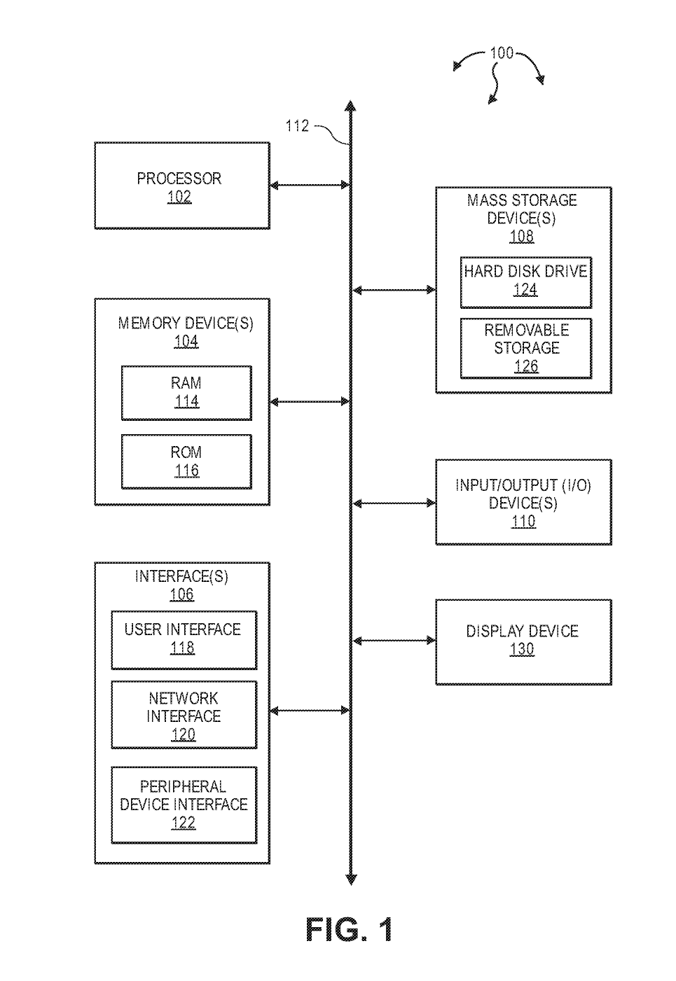

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/0 device(s) 110 include cursor control devices, keyboards, keypads, barcode scanners, microphones, monitors or other display devices, speakers, printers, network interface cards, modems, cameras, lenses, radars, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 118 and peripheral device interface 122.

Bus 112 allows processor(s) 102, memory device(s) 104, interface(s) 106, mass storage device(s) 108, and I/0 device(s) 110 to communicate with one another, as well as other devices or components coupled to bus 112. Bus 112 represents one or more of several types of bus structures, such as a system bus, PCI bus, IEEE 1394 bus, USB bus, and so forth.

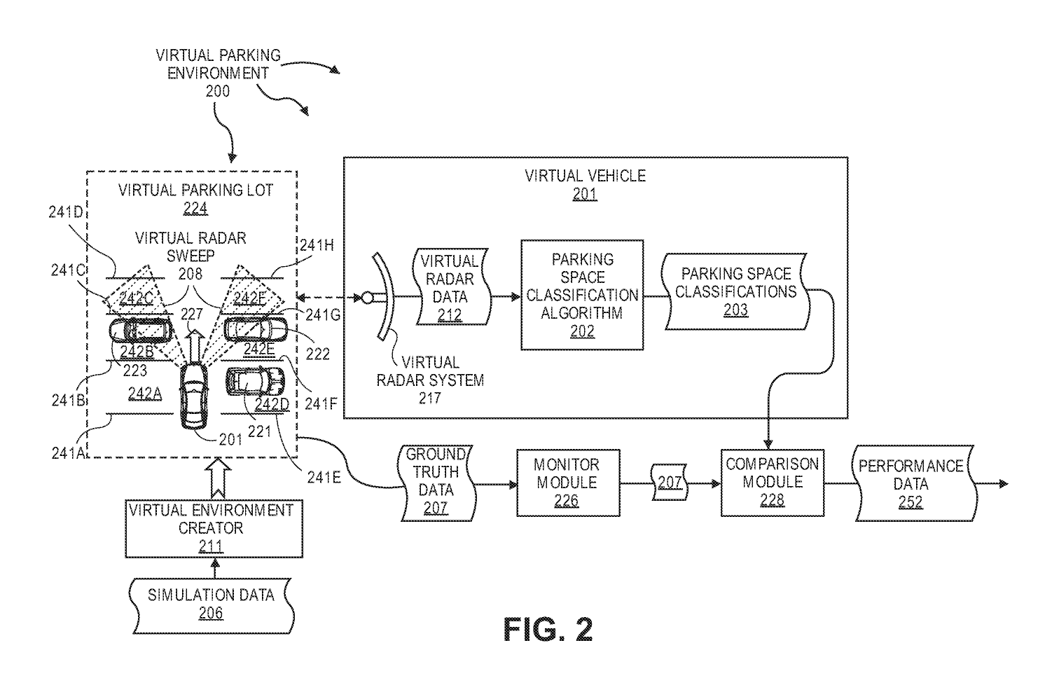

FIG. 2 illustrates an example computer architecture 200 that facilitates using virtual data to test parking space detection. Computer architecture 200 can be used to test parking space detection for a vehicle, such as, for example, a car, a truck, a bus, or a motorcycle. Referring to FIG. 2, computer architecture 200 includes virtual environment creator 211, monitor module 226, and comparison module 228.

In general, virtual environment creator 211 can create virtual parking environments (e.g., three dimensional parking environments) from simulation data. The virtual parking environments can be used to test parking space classification algorithms. A virtual parking environment can be created to include a plurality of virtual parking space markings, one or more virtual vehicles, and a test virtual vehicle. The plurality of virtual parking space markings can mark out a plurality of virtual parking spaces. The one or more virtual vehicles can be parked in one or more of the plurality of virtual parking spaces.

The test virtual vehicle can include a virtual radar system. The virtual radar system can detect virtual radar reflections from virtual objects within the virtual parking environment. The test virtual vehicle can be virtually driven within the virtual parking environment. During movement within the virtual parking environment, the virtual radar system can detect virtual reflections from virtual objects in the virtual parking environment. Detected virtual reflections can be from any virtual objects in range of the virtual radars mounted to the test virtual vehicle, including other virtual vehicles and parking space markings.

In one aspect, the virtual radar system includes a virtual radar on each of four corners of the virtual test vehicle.

The virtual radar system can send the virtual radar data to a parking space classification algorithm that is to be tested. The parking space classification algorithm can receive the virtual radar data from the virtual radar system. The parking space classification algorithm can use the virtual radar data to classify parking spaces within the virtual parking environment as occupied or unoccupied. The parking space classification algorithm can send parking space classifications to comparison module 228.

Monitor module 226 can monitor the virtual parking environment created, by virtual environment creator 211. Monitor module 226 can receive ground truth data for the virtual parking environment. The ground truth data indicates which parking places are occupied and which parking places are unoccupied within the virtual parking environment. Monitor module 226 can send the ground truth data to comparison module 228.

Comparison module 228 can compare parking space classifications to the ground truth data to assess the performance of the parking space classification algorithm.

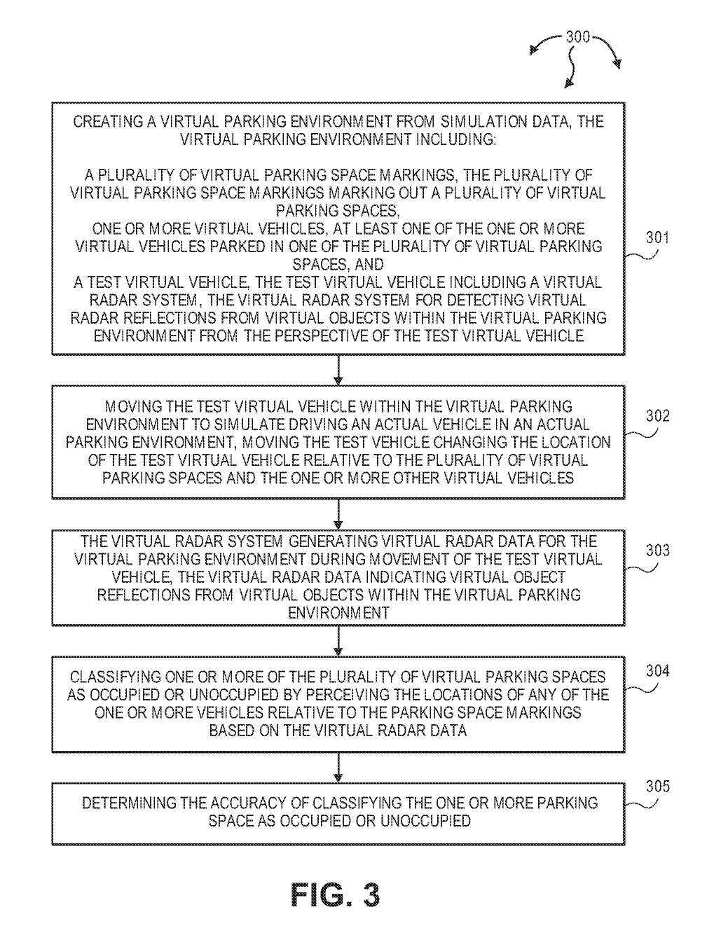

FIG. 3 illustrates a flow chart of an example method 300 for using virtual data to test parking space detection. Method 300 will be described with respect to the components and data of environment 200.

Method 300 includes creating a virtual parking environment from simulation data. the virtual parking environment include a plurality of virtual parking space markings, one or more virtual vehicles, and a test virtual vehicle (301). The plurality of virtual parking space markings marking out a plurality of virtual parking spaces. At least one of the one or more virtual vehicles parked in one of the plurality of virtual parking spaces. The test virtual vehicle includes a virtual radar system. The virtual radar system is for detecting virtual radar reflections from virtual objects within the virtual parking environment from the perspective of the test virtual vehicle.

For example, virtual environment creator 211 can create virtual parking lot 224 (e.g., a three dimensional parking lot) from simulation data 206. Simulation data 206 can be generated by a test engineer or developer using three dimensional (“3D”) modeling and animation tools. Virtual parking lot 224 includes virtual parking space markings 241A-241H marking out virtual parking spaces 242A-242F. Virtual parking lot 224 also includes virtual vehicles 221, 222, and 223. As depicted, virtual vehicle 221 is parked in virtual parking place 242D, virtual vehicle 222 is parking in virtual parking place 242E, and virtual vehicle 223 is parked in virtual parking place 242B.

Virtual vehicle 201 is driving in virtual parking lot 224. Virtual vehicle 201 includes virtual radar system 217. Virtual radar system 217 is for detecting virtual radar reflections from virtual objects within virtual parking lot 224 from the perspective of virtual vehicle 201.

Method 300 includes moving the test virtual vehicle within the virtual parking environment to simulate driving an actual vehicle in an actual parking environment, moving the test vehicle changing the location of the test virtual vehicle relative to the plurality of virtual parking spaces and the one or more other virtual vehicles (302). For example, virtual vehicle 201 can move in direction 227 to simulate driving an actual vehicle in an actual parking lot. Moving virtual vehicle 201 changes the location of virtual vehicle 201 relative to virtual parking spaces 242A-242F and virtual vehicles 221, 222, and 223.

Method 300 incudes the virtual radar system generating virtual radar data for the virtual parking environment during movement of the test virtual vehicle, the virtual radar data indicating virtual object reflections from virtual objects within the virtual parking environment (303). For example, virtual radar system 217 can generate virtual radar data 212 during movement of virtual vehicle 201. Virtual radar system 211 can include virtual radars mounted on the front corners of virtual vehicle 201. The radar units can produce virtual radar sweeps 208. Virtual radar data 212 can include virtual radar data collected from virtual radar sweeps 208. Virtual radar data 212 can indicate virtual object reflections from portions of virtual vehicles 222 and 223 and portions of virtual parking space markings 241B, 241C, 241D, 241F, 241G, and 241H.

Method 300 includes classifying one or more of the plurality of virtual parking spaces as occupied or unoccupied by perceiving the locations of any of the one or more vehicles relative to the parking space markings based on the virtual radar data (304). For example, parking space classification algorithm 202 can classify virtual parking spaces 242B, 242C, 242E, and 242F as occupied or unoccupied. Parking space classification algorithm 202 can classify virtual parking spaces 242B, 242C, 242E, and 242F by perceiving the locations of virtual vehicles 222 and 223 relative to virtual parking space markings 241B, 241C, 241D, 241F, 241G, and 241H based on virtual radar data 212.

In one aspect, parking space classification algorithm 202 classifies virtual parking spaces 242B and 242E as occupied. Parking space classification algorithm 202 can perceive the location of vehicle 223 relative to virtual parking space markings 241B and 241C based on virtual radar data 212. Similarly, parking space classification algorithm 202 can perceive the location of vehicle 222 relative to virtual parking space markings 241F and 241G based on virtual radar data 212.

Parking space classification algorithm 202 can classify virtual parking spaces 242C and 242F as unoccupied. Parking space classification algorithm 202 can perceive that the virtual space between virtual parking space markings 241C and 241D is open. Similarly, parking space classification algorithm 202 can perceive that the virtual space between virtual parking space markings 241G and 241H is open.

In other aspects, parking space classification algorithm 202 (incorrectly) classifies one or both of virtual parking spaces 242B and 242E as unoccupied and/or (incorrectly) classifies one or both of virtual parking spaces 242C and 242F as occupied.

Parking space classification algorithm 202 outputs the parking space classifications in parking space classifications 203.

Method 300 includes determining the accuracy of classifying the one or more parking spaces as occupied or unoccupied (305). For example, comparison module 228 can determine the accuracy of parking space classifications 203. Monitor module 226 can monitor ground truth data 207 for virtual parking lot environment 224. Monitor module 226 can pass ground truth data 207 to comparison module 228. Ground truth data 207 indicates the actual occupancy of virtual parking spaces 242A-242F. Comparison module 228 can compare parking space classifications 203 to ground truth data 207 to calculate performance data 252 for parking space classification algorithm 202.

Performance data 252 can indicate the calculated accuracy of parking space classifications 203 relative to ground truth data 207. When parking space classifications 203 correctly indicates the occupancy status of virtual parking spaces, comparison module 228 calculates increased accuracy for parking space classifications 203. For example, it may be that parking space classifications 203 indicate that virtual parking space 242F is unoccupied. Ground truth data 207 also indicates that virtual parking space 242F is unoccupied. Thus, comparison module 228 can calculate an increased accuracy for parking space calculations 203.

On the other hand, it may be that parking space classifications 203 indicate that virtual parking space 242B is unoccupied. However, ground truth data 207 indicates (correctly) that virtual parking space 242B is occupied. Thus, comparison module 228 can calculate a decreased accuracy for parking space calculations 203.

Determining the accuracy of parking space classifications 203 can include determining the error in parking space classifications 203 relative to ground truth data 207.

Virtual vehicle 201 can be moved to a different location in virtual parking lot 224. Portions of method 300, such as, for example, 303, 304, and 305, can be performed again to generate additional performance data 252.

An engineer can make adjustments to parking space classification algorithm 202 based on performance data 252. As such, performance data 252 (i.e., performance data from testing parking space classification algorithm 202 in a virtual parking lot) can be used to facilitate more efficient development of parking space classification algorithm 202. After adjustments are made, parking space classification algorithm 202 can be tested further. Virtual environment creator 211 can create different virtual environments (e.g., different parking lots, different parking structures, etc.) to further test parking space classification algorithm 202. Within each different virtual environment, further testing can be performed in accordance with method 300.

When parking space classification algorithm 202 is performing reasonably on virtual data, parking space classification algorithm 202 can be tested using real world data. Overall, real world testing can be (possibly significantly) reduced with minimal, if any, sacrifice in performance.

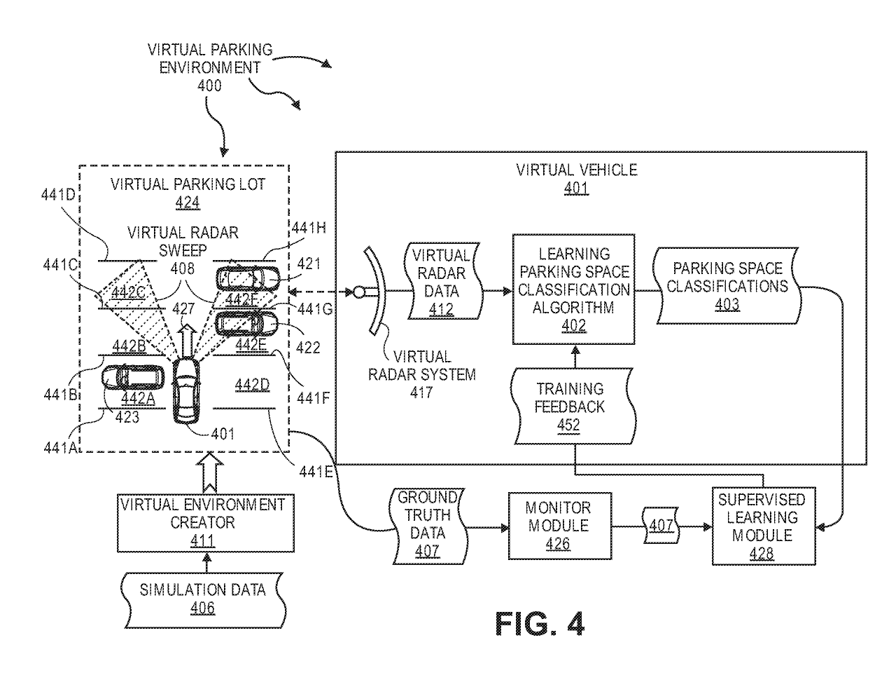

FIG. 4 illustrates an example computer architecture that facilitates using virtual data to train parking space detection. Computer architecture 400 can be used to train parking space detection for a vehicle, such as, for example, a car, a truck, a bus, or a motorcycle. Referring to FIG. 4, computer architecture 400 includes virtual environment creator 411, monitor module 426, and supervised learning module 428.

In general, virtual environment creator 411 can create virtual parking environments (e.g., three dimensional parking environments) from simulation data. The virtual parking environments can be used to train parking space classification algorithms. A virtual parking environment can be created to include a plurality of virtual parking space markings, one or more virtual vehicles, and a test virtual vehicle. The plurality of virtual parking space markings can mark out a plurality of virtual parking spaces. The one or more virtual vehicles are parked in one or more of the plurality of virtual parking spaces.

The test virtual vehicle can include a virtual radar system. The virtual radar system can detect virtual radar reflections from virtual objects within the virtual parking environment. The test vehicle can be driven within the virtual parking environment. During movement within the virtual parking environment, the radar system can detect virtual reflections from virtual objects in the virtual parking environment. Detected virtual reflections can be from any virtual objects in range of the virtual radars mounted to the test virtual vehicle, including other virtual vehicles and parking space markings.

In one aspect, the virtual radar system includes a virtual radar on each of four corners of the virtual test vehicle.

The virtual radar system can send the virtual radar data to a parking space classification algorithm that is to be trained. The parking space classification algorithm can receive the virtual radar data from the virtual radar system. The parking space classification algorithm can use the virtual radar data to classify parking spaces within the virtual parking environment as occupied or unoccupied. The parking space classification algorithm can send parking space classifications to supervised learning module 428.

Monitor module 426 can monitor the virtual parking environment created by virtual environment creator 411. Monitor module 426 can receive ground truth data for the virtual parking environment. The ground truth data indicates which parking places are occupied and which parking places are unoccupied within the virtual parking environment. Monitor module 426 can send the ground truth data to supervised learning module 428.

Supervised learning module 428 can compare parking space classifications to the ground truth data to assess the performance of the parking space classification algorithm. Based on the assessed performance, supervised learning module 428 can generate training feedback. The training feedback can be provided back to the parking space classification algorithm. The training feedback can be used to alter the parking space classification algorithm to improve subsequent parking space classifications.

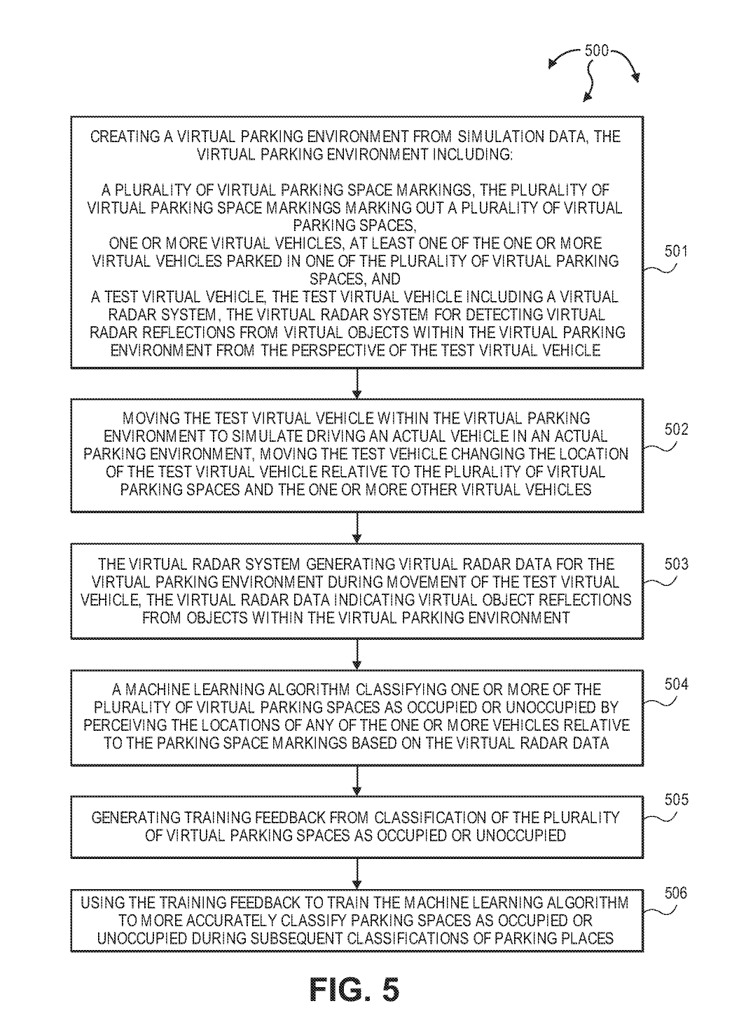

FIG. 5 illustrates a flow chart of an example method 500 for using virtual data to train parking space detection. Method 500 will be described with respect to the components and data of environment 400.

Method 500 incudes creating a virtual parking environment from simulation data. the virtual parking environment include a plurality of virtual parking space markings, one or more virtual vehicles, and a test virtual vehicle (501). The plurality of virtual parking space markings marking out a plurality of virtual parking spaces. At least one of the one or more virtual vehicles parked in one of the plurality of virtual parking spaces. The test virtual vehicle includes a virtual radar system. The virtual radar system is for detecting virtual radar reflections from virtual objects within the virtual parking environment from the perspective of the test virtual vehicle.

For example, virtual environment creator 411 can create virtual parking lot 424 (e.g., a three dimensional parking lot) from simulation data 406. Simulation data 406 can be generated by a test engineer or developer using three dimensional (“3D”) modeling and animation tools. Virtual parking lot 424 includes virtual parking space markings 441A-441H marking out virtual parking spaces 442A-442F. Virtual parking lot 424 also includes virtual vehicles 421, 422, and 423. As depicted, virtual vehicle 421 is parked in virtual parking place 442F, virtual vehicle 422 is parking in virtual parking place 442E, and virtual vehicle 423 is parked in virtual parking place 442A.

Virtual vehicle 401 is driving in virtual parking lot 424. Virtual vehicle 401 includes virtual radar system 417. Virtual radar system 417 is for detecting virtual radar reflections from virtual objects within virtual parking lot 424 from the perspective of virtual vehicle 401.

Method 500 includes moving the test virtual vehicle within the virtual parking environment to simulate driving an actual vehicle in an actual parking environment, moving the test vehicle changing the location of the test virtual vehicle relative to the plurality of virtual parking spaces and the one or more other virtual vehicles (502). For example, virtual vehicle 401 can move in direction 427 to simulate driving an actual vehicle in an actual parking lot. Moving virtual vehicle 401 changes the location of virtual vehicle 401 relative to virtual parking spaces 442A-442F and virtual vehicles 421, 422, and 423.

Method 500 incudes the virtual radar system generating virtual radar data for the virtual parking environment during movement of the test virtual vehicle, the virtual radar data indicating virtual object reflections from virtual objects within the virtual parking environment (503). For example, virtual radar system 417 can generate virtual radar data 412 during movement of virtual vehicle 401. Virtual radar system 411 can include virtual radars mounted on the front corners of virtual vehicle 401. The radar units can produce virtual radar sweeps 408. Virtual radar data 412 can include virtual radar data collected from virtual radar sweeps 408. Virtual radar data 412 can indicate virtual object reflections from portions of virtual vehicles 421 and 422 and portions of virtual parking space markings 441B, 441C, 441D, 441F, 441G, and 441H.

Method 500 includes a machine learning algorithm classifying one or more of the plurality of virtual parking spaces as occupied or unoccupied by perceiving the locations of any of the one or more vehicles relative to the parking space markings based on the virtual radar data (504). For example, learning parking space classification algorithm 402 can classify virtual parking spaces 442B, 442C, 442E, and 442F as occupied or unoccupied. Learning parking space classification algorithm 402 can classify virtual parking spaces 442B, 442C, 442E, and 442F by perceiving the locations of virtual vehicles 421 and 422 relative to virtual parking space markings 441B, 441C, 441D, 441F, 441G, and 441H based on virtual data 412.

In one aspect, learning parking space classification algorithm 402 classifies virtual parking spaces 442E and 442F as occupied. Learning parking space classification algorithm 402 can perceive the location of vehicle 421 relative to virtual parking space markings 441H and 441G based on virtual radar data 412. Similarly, learning parking space classification algorithm 402 can perceive the location of vehicle 422 relative to virtual parking space markings 441G and 441F based on virtual radar data 412.

Learning parking space classification algorithm 402 can classify virtual parking spaces 442B and 442C as unoccupied. Learning parking space classification algorithm 402 can perceive that the virtual space between virtual parking space markings 441C and 441D is open. Similarly, learning parking space classification algorithm 402 can perceive that the virtual space between virtual parking space markings 441B and 441C is open.

In other aspects, parking space classification algorithm 402 (incorrectly) classifies one or both of virtual parking spaces 442F and 442E as unoccupied and/or (incorrectly) classifies one or both of virtual parking spaces 442C and 442B as occupied.

Learning parking space classification algorithm 402 outputs the parking space classifications in parking space classifications 403.

Method 500 includes generating training feedback from classification of the plurality of virtual parking spaces as occupied or unoccupied (505). For example, supervised learning module 428 can generate training feedback 452 from classification of virtual parking spaces 442A-442F as occupied or unoccupied. Supervised learning module 428 can determine the accuracy of parking space classifications 403. Monitor module 426 can monitor ground truth data 407 for virtual parking lot environment 424. Monitor module 426 can pass ground truth data 407 to supervised learning module 428. Ground truth data 407 indicates the actual occupancy of virtual parking spaces 442A-442F. Supervised learning module 428 can compare parking space classifications 403 to ground truth data 407 to calculate the performance of learning parking space classification algorithm 402.

The performance data can indicate the calculated accuracy of parking space classifications 403 relative to ground truth data 407. When parking space classifications 403 correctly indicates the occupancy status of virtual parking spaces, supervised learning module 428 calculates increased accuracy for parking space classifications 403. For example, it may be that parking space classifications 403 indicate that virtual parking space 442C is unoccupied. Ground truth data 407 also indicates that virtual parking space 442C is unoccupied. Thus, supervised learning module 428 can calculate an increased accuracy for parking space calculations 403.

On the other hand, it may be that parking space classifications 403 indicate that virtual parking space 442E is unoccupied. However, ground truth data 407 indicates (correctly) that virtual parking space 442E is occupied. Thus, supervised learning module 428 can calculate a decreased accuracy for parking space calculations 403.

Determining the accuracy of parking space classifications 403 can include determining the error in parking space classifications 403 relative to ground truth data 407. From the calculated accuracy of parking space classifications 403 relative to ground truth data 407, supervised learning module 428 can generate training feedback 452. Generating training feedback 452 can include annotating virtual radar data 412 with the actual locations of vehicles 421, 422, and 423.

Method 500 includes using the training feedback to train the machine learning algorithm to more accurately classify parking spaces as occupied or unoccupied during subsequent classifications of parking places (506). For example, supervised learning module 428 can send training feedback 452 to learning parking space classification algorithm 402. Learning parking space classification algorithm 402 can use training feedback 452 to change internal values, internal calculations, internal operations, internal weightings, etc. Changes to the internal functionality of learning parking space classification algorithm 402 can increase the accuracy of subsequently classifying parking spaces as occupied or unoccupied.

Virtual vehicle 401 can be moved to a different location in virtual parking lot 424. Portions method 500, such as, for example, 503, 504, 505, and 506, can be performed again to generate additional training feedback 452.

Accordingly, machine learning can be used to facilitate more efficient development of learning parking space classification algorithm 402. Different virtual environments (e.g., different parking lots, different parking structures, etc.) can be created to train learning parking space classification algorithm 402. Within each different virtual environment, further training can be performed in accordance with method 500.

Supervised learning module 428 can also output performance data for review by engineers. Thus, after learning parking space classification algorithm 402 is performing reasonably based on automated training, engineers can intervene to further improve the performance of learning parking space classification algorithm 402. When engineers are satisfied with the performance of learning parking space classification algorithm 402, learning parking space classification algorithm 402 can then be tested and further trained using real world data. Overall, real world testing can be (possibly significantly) reduced.

In some aspects, a virtual parking environment is used to both test and train a parking space classification algorithm.

In one aspect, learning parking space classification algorithm 402 is a neural network. The neural network can be architected in accordance with a multi-layer (or “deep”) model. A multi-layer neural network model can include an input layer, a plurality of hidden layers, and an output layer. A multi-layer neural network model may also include a loss layer. For classification of sensor data (e.g., virtual or real radar data), values in the sensor data are assigned to input nodes and then fed through the plurality of hidden layers of the neural network. The plurality of hidden layers can perform a number of non-linear transformations. At the end of the transformations, an output node yields a value that corresponds to the class (e.g., occupied parking space or non-occupied parking space.) inferred by the neural network.

The neural network can be trained to distinguish between occupied parking spaces and unoccupied parking spaces. For example, training feedback 452 can used to modify algorithms used in the hidden layers of the neural network.

A deep, learning-based technique that replaces existing fitting and regression-type techniques can be utilized. The deep learning-based technique can achieve stable, free-space boundary estimation in a virtual or real parking environment. The technique can be real-time, work on fewer points, and therefore provide a moving boundary estimate instantaneously. The approach can also be more scalable, as the hidden layers of a deep neural network can be trained to learn and overcome the idiosyncrasies of the radar spurious reflections.

In general, parking space classification algorithms can be used for any type of three-dimensional virtual area in which one or more virtual vehicles can be parked, such as a parking lot, parking garage, parking structure, parking area, and the like. Virtual radar sensors on a virtual vehicle are utilized to gather virtual data about a parking environment, such as, for example, a parking lot. The virtual radar detection data is provided to a parking space classification algorithms as an input. Parking space classification algorithms can be configured and/or trained to recognize parked vehicles and conflicting data regarding debris, shopping carts, street lamps, traffic signs, pedestrians, etc. Parking space classification algorithms can be configured to filter out spurious radar data, also known as ghost objects, such as debris or shopping carts in the parking lot, fixed objects such as light fixtures, pedestrians, faulty radar artifacts such as unexpected reflections, etc.

In one aspect, parking space classification algorithms processes virtual radar detection data to estimate virtual parking space boundaries and to approximate the virtual parking space boundaries as splines. A parking space classification algorithm outputs spline estimations. A parking module then utilizes the spline estimates to detect available parking spaces. The spline estimates are updated as the vehicle virtually navigates a virtual parking lot.

In this specification and the following claims, a “spline” is defined as a numeric function that is piecewise-defined by polynomial functions. A spline can include a relatively high degree of smoothness at the places where the polynomial pieces connect. A spline is defined to include any of: a Bezier curve, a Hermite spline, a cubic spline, a b-spline, a non-uniform rational b-spline (NURB), a beta-spline, a v-spline, etc.

In this specification and the following claims, “spline data” is defined as any data related to calculating a solution to the polynomial functions included in a numeric function for a spline.

In one aspect, a neural network can be designed with the raw radar detections (M points per instance) collected for T time instances, to give M×T input points (x,y). The output of the neural network can be a “spline” with N points (x,y), representing a smooth boundary of the parking space on the lateral side of the vehicle, repeated for both sides. The architecture of the neural network can be deep, for example, with multiple (7 or more) hidden layers. A loss layer can encompass a Euclidean type of loss to allow output akin to a regression output to represent continuous values in the x,y plane.

The outputs can be the “splines” which estimate the free spaces for a parking environment. Splines can move along with the vehicle, tracing the boundary of the parking spaces available essentially instantaneously as a moving input of T time instances is being processed.

After testing and/or training on virtual data, a parking space classification algorithm can be ported to a real vehicle for further testing and/or training. In an actual parking environment, a vehicle (e.g., a test vehicle) equipped with multiple radar units (e.g., 4 corner radar units) can navigate a real parking environment (e.g., a parking lot) searching for parking spaces. As the vehicle moves, each radar unit emits radio waves. Reflections from the emitted radio waves signals can be collected back at the radar units and processed to identify objects.

Parking navigation can be repeated with several test drivers to achieve greater multiple hours (e.g., 20 or more hours) of driving data at nominal and off-nominal parking space driving speeds. Collected radar data can be compared with aerial data. The ground truth of the real parking environment can be obtained at the same instance, and with the same space configurations consistent with the radar data collections. The ground truth data can be aerial imagery and can give a plan view of the parking environment from top-down.

Radar systems can include radar units that use any of bistatic radar, continuous-wave radar, Doppler radar, fm-cw radar, monopulse radar, passive radar, planar array radar, pulse-doppler, synthetic aperture radar, etc. Virtual radar systems can include virtual radar units that simulate any of bistatic radar, continuous-wave radar, Doppler radar, fm-cw radar, monopulse radar, passive radar, planar array radar, pulse-doppler, synthetic aperture radar, etc.

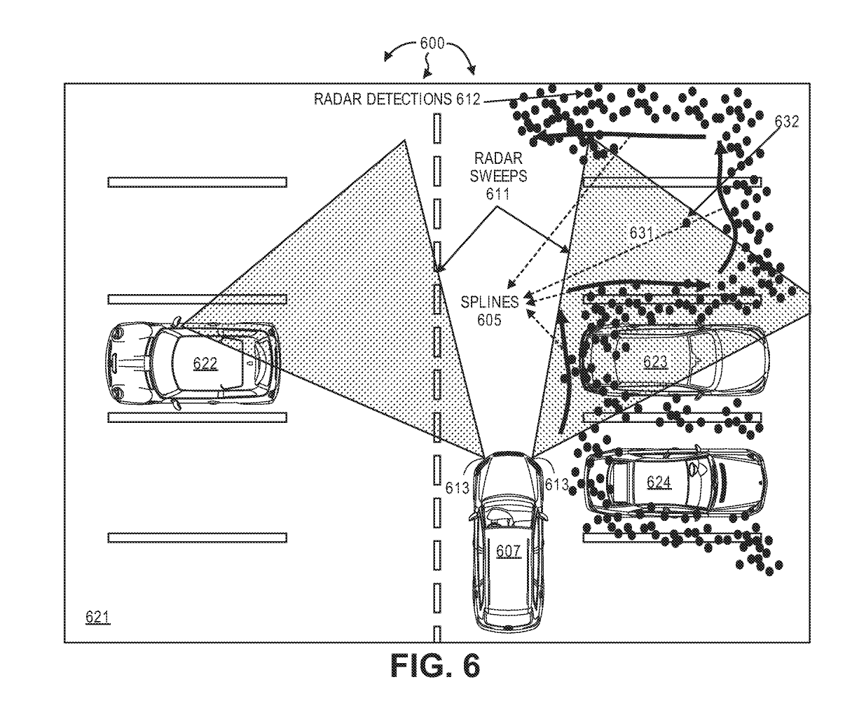

FIG. 6 illustrates an example parking environment 600 (which can be virtual or real). As depicted, an example parking lot 621 contains three parked vehicles 622, 623, and 624. Parking lot 621 also contains a moving vehicle 607 which is in search of an available parking space. Moving vehicle 607 is equipped with radar sensors 613 and a parking space classification algorithm (not shown).

Radar sensors 613 are configured to perform radar sweeps 611 and to detect objects in the parking lot as radar detections 612 (also referred to as “radar data”). Radar sensors 613 can provide radar detections 612 to the parking space classification algorithm for processing.

The parking space classification algorithm can process radar detections 612 and estimate the perimeter of the radar detections 612 as splines 605. Radar detections 612 can include spurious detection data 632 such as cans, or other debris, in the parking lot. The parking space classification algorithm system can be tested and/or trained to differentiate between radar detection data 612 that is relevant data and radar detection data 612 that is spurious data.

The parking space classification algorithm can use splines 605 to estimate available parking space(s) 631. As moving vehicle 607 navigates parking lot 621, radar sensors 613 can continue to perform radar sweeps 611 to update radar detections 612. The vehicle computer system 601 can process updated radar detections 612 to continually update splines 605.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can transform information between different formats, such as, for example, simulation data, virtual parking environments, virtual radar data, radar data, parking space classifications, ground truth data, performance data, training feedback, etc.

System memory can be coupled to the one or more processors and can store instructions (e.g., computer-readable instructions, computer-executable instructions, etc.) executed by the one or more processors. The system memory can also be configured to store any of a plurality of other types of data generated by the described components, such as, for example, simulation data, virtual parking environments, virtual radar data, radar data, parking space classifications, ground truth data, performance data, training feedback, etc.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash or other vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

What is claimed:

1. A method for virtually testing parking space detection, the method comprising:
creating a virtual environment, including one or more virtual parking spaces and a virtual vehicle with a virtual radar system;
the virtual radar system generating virtual radar data indicating virtual object reflections from virtual objects within the virtual environment;
classifying a virtual parking space as occupied or unoccupied based on the virtual radar data; and
determining the accuracy of the classifications.

2. The method of claim 1, wherein classifying a virtual parking space as occupied or unoccupied based on the virtual radar data comprises a parking space classification algorithm classifying a parking space as occupied or unoccupied.

3. The method of claim 1, wherein creating a virtual environment comprises creating a virtual parking lot from simulation data.

4. The method of claim 1, further comprising accessing ground truth data indicating actual locations of one or more virtual vehicles within the virtual environment; and
wherein determining the accuracy of the classifications comprises comparing the classifications to the ground truth data.

5. The method of claim 1, further comprising generating training feedback from the determined accuracy of the classifications, the training feedback for training a learning parking space classification algorithm.

6. The method of claim 5, wherein the learning parking space classification algorithm is a neural network.

7. A computer system, the computer system comprising:
one or more processors;
system memory coupled to one or more processors, the system memory storing instructions that are executable by the one or more processors; and
the one or more processors configured to execute the instructions stored in the system memory to test vehicle parking detection in a virtual environment, including the following:
create a virtual parking environment from simulation data, the virtual parking environment including:
a plurality of virtual parking space markings, the plurality of virtual parking space markings marking out a plurality of virtual parking spaces,
one or more virtual vehicles, at least one of the one or more virtual vehicles parked in one of the plurality of virtual parking spaces, and
a test virtual vehicle, the test virtual vehicle including a virtual radar system, the virtual radar system for detecting virtual radar reflections from virtual objects within the virtual parking environment from the perspective of the test virtual vehicle;
move the test virtual vehicle within the virtual parking environment to simulate driving an actual vehicle in an actual parking environment, moving the test vehicle changing the location of the test virtual vehicle relative to the plurality of virtual parking spaces and the one or more other virtual vehicles;
generate, at the virtual radar system, virtual radar data for the virtual parking environment during movement of the test virtual vehicle, the virtual radar data indicating virtual object reflections from objects within the virtual parking environment;
classify one or more of the plurality of virtual parking spaces as occupied or unoccupied by perceiving the locations of any of the one or more vehicles relative to the parking space markings based on the virtual radar data; and
determine the accuracy of classifying the one or more parking space classifications as occupied or unoccupied.

8. The computer system of claim 7, wherein the one or more processors configured to execute the instructions to classify one or more of the plurality of virtual parking spaces as occupied or unoccupied comprises the one or more processors configured to execute the instructions to have a machine learning algorithm classify the one or more of the plurality of virtual parking spaces as occupied or unoccupied; and
wherein the one or more processors configured to execute the instructions to determine the accuracy of classifying the one or more parking space classifications as occupied or unoccupied comprises the one or more processors configured to execute the instructions to determine error in classifying the one or more parking space classifications as occupied or unoccupied.

9. The computer system of claim 8, further comprising the one or more processors configured to execute the instructions to:
generate training feedback based on the determined error; and
use the training feedback to train the machine learning algorithm to more accurately classify parking spaces as occupied or unoccupied during subsequent classifications of parking places.

10. The computer system of claim 9, wherein the one or more processors configured to execute the instructions to generate training feedback based on the determined error in the one or more parking space classifications comprise the one or more processors configured to execute the instructions to annotate the virtual radar data with actual vehicle locations.

11. The computer system of claim 9, wherein the one or more processors configured to execute the instructions to have a machine learning algorithm classify the one or more of the plurality of virtual parking spaces as occupied or unoccupied comprises the one or more processors configured to execute the instructions to have a neural network classify the one or more of the plurality of virtual parking spaces as occupied or unoccupied.

12. The computer system of claim 7, further comprising the one or more processors configured to execute the instructions to:
further move the test virtual vehicle within the virtual parking environment to further change the location of the test virtual vehicle relative to the plurality of virtual parking spaces and the one or more other virtual vehicles;
generate, at the virtual radar system, further virtual radar data for the virtual parking environment during the further movement of the test virtual vehicle, the further virtual radar data indicating virtual object reflections from objects within the virtual parking environment; and
again classify one or more of the plurality of virtual parking spaces as occupied or unoccupied by perceiving the locations of any of the one or more vehicles relative to the parking space markings based on the further virtual radar data.

13. The computer system of claim 7, wherein the one or more processors configured to execute the instructions to create a virtual parking environment comprises the one or more processors configured to execute the instructions to create a three dimensional virtual parking environment.

14. The computer system of claim 7, wherein the one or more processors configured to execute the instructions to classify one or more of the plurality of virtual parking spaces as occupied or unoccupied comprises the one or more processors configured to execute the instructions to calculate spline estimates for parking space boundaries.

15. A computer system, the computer system comprising:
one or more processors;
system memory coupled to one or more processors, the system memory storing instructions that are executable by the one or more processors;
a machine learning algorithm; and
the one or more processors configured to execute the instructions stored in the system memory to train vehicle parking detection in a virtual environment, including the following:
create a virtual parking environment from simulation data, the virtual parking environment including:
a plurality of virtual parking space markings, the plurality of virtual parking space markings marking out a plurality of virtual parking spaces,
one or more virtual vehicles, at least one of the one or more virtual vehicles parked in one of the plurality of virtual parking spaces, and
a test virtual vehicle, the test virtual vehicle including a virtual radar system, the virtual radar system for detecting virtual radar reflections from virtual objects within the virtual parking environment from the perspective of the test virtual vehicle;
move the test virtual vehicle within the virtual parking environment to simulate driving an actual vehicle in an actual parking environment, moving the test vehicle changing the location of the test virtual vehicle relative to the plurality of virtual parking spaces and the one or more other virtual vehicles;
generate, at the virtual radar system, virtual radar data for the virtual parking environment during movement of the test virtual vehicle, the virtual radar data indicating virtual object reflections from objects within the virtual parking environment;
classify, at the machine learning algorithm, one or more of the plurality of virtual parking spaces as occupied or unoccupied by perceiving the locations of any of the one or more vehicles relative to the parking space markings based on the virtual radar data;
generate training feedback based on classification of the plurality of virtual parking spaces as occupied or unoccupied and actual vehicle locations of the one or more virtual vehicles within the virtual parking environment; and
use the training feedback to train the machine learning algorithm to more accurately classify parking spaces as occupied or unoccupied during subsequent classifications of parking places.

16. The computer system of claim 15, wherein the one or more processors configured to execute the instructions to generate training feedback from classification of the plurality of virtual parking spaces as occupied or unoccupied comprises:
the one or more processors configured to execute the instructions to determine error in classifying the one or more parking space classifications as occupied or unoccupied; and
the one or more processors configured to execute the instructions to annotate the virtual radar data with actual vehicle locations.

17. The computer system of claim 15, wherein the one or more processors configured to execute the instructions to use the training feedback to train the machine learning algorithm comprises the one or more processors configured to execute the instructions to use the training feedback to train a neural network.

18. The computer system of claim 15, further comprising the one or more processors configured to execute the instructions to subsequent to using the training feedback to train the machine learning algorithm:
further move the test virtual vehicle within the virtual parking environment to further change the location of the test virtual vehicle relative to the plurality of virtual parking spaces and the one or more other virtual vehicles;
generate, at the virtual radar system, further virtual radar data for the virtual parking environment during the further movement of the test virtual vehicle, the further virtual radar data indicating virtual object reflections from objects within the virtual parking environment; and
again classify, at the machine learning algorithm. one or more of the plurality of virtual parking spaces as occupied or unoccupied by perceiving the locations of any of the one or more vehicles relative to the parking space markings based on the further virtual radar data.

19. The computer system of claim 15, wherein the one or more processors configured to execute the instructions to create a virtual parking environment comprises the one or more processors configured to execute the instructions to create a three dimensional virtual parking environment.

20. The computer system of claim 15, wherein the one or more processors configured to execute the instructions to classify one or more of the plurality of virtual parking spaces as occupied or unoccupied comprises the one or more processors configured to execute the instructions to calculate spline estimates for parking space boundaries.
